(19) United States
(12) Patent Application Publication
(10) Pub. No.: US 2026/0146596 A1
(43) Pub. Date: May 28, 2026

(54) PUMP AND A SENSOR CLEANING DEVICE INCLUDING THE SAME

(71) Applicants: HYUNDAI MOTOR COMPANY, Seoul (KR); KIA CORPORATION, Seoul (KR); MYUNG HWA IND. CO., LTD., Seoul (KR)

(72) Inventors: Sang Hyuk Ha, Hwaseong-si (KR); Seung Hyun Lee, Hwaseong-si (KR); Sang Woo Kim, Hwaseong-si (KR); Ji Hoon Lim, Hanam-si (KR)

(73) Assignees: HYUNDAI MOTOR COMPANY, Seoul (KR); KIA CORPORATION, Seoul (KR); MYUNG HWA IND. CO., LTD, Seoul (KR)

(21) Appl. No.: 19/242,512

(22) Filed: Jun. 18, 2025

(30) Foreign Application Priority Data
Nov. 25, 2024 (KR) 10-2024-0169208

(51) Int. Cl. F04B 45/04; B60S 1/54; B60S 1/56; F04B 45/047; F04B 53/10

(52) U.S. Cl. CPC F04B 45/043; B60S 1/54; B60S 1/56; F04B 45/047; F04B 53/102

(57) ABSTRACT

A pump for a sensor cleaning device may include: a housing; a drive shaft configured to rotate within the housing; a plurality of diaphragms arranged within the housing and connected to the drive shaft; and a plurality of chambers defined by the housing and each of the plurality of diaphragms. The plurality of chambers may be configured to draw in and discharge a fluid by rotating of the drive shaft. In particular, the fluid may be drawn into or discharged from each chamber per unit rotation of the drive shaft.

### CROSS-REFERENCE TO RELATED APPLICATION

This application claims, under 35 U.S.C. §119(a), the benefit of and priority to Korean Patent Application No. 10-2024-0169208, filed on Nov. 25, 2024, the entire contents of which are incorporated herein by reference.

### TECHNICAL FIELD

The present disclosure relates to a pump.

### BACKGROUND

A pump is a device that moves fluid from one place to another. For example, a diaphragm pump, which is a type of positive displacement pump, is configured to transfer fluid by repeating contracting and expanding a diaphragm (e.g., the contraction and expansion strokes of the diaphragm) driven by a motor.

The diaphragm pump may use an air-distribution method for spraying oil or the like, or a motor-driven method suitable for small pumps.

The above information disclosed in this Background section is only for enhancement of understanding of the background of the present disclosure, and therefore it may contain information that does not form the prior art that is already known to one having ordinary skill in the art.

### SUMMARY

The present disclosure provides a pump that can offer improved performance at a given size and a sensor cleaning device including the same.

The present disclosure also provides a pump that can supply a fluid for cleaning a sensor of a vehicle in a simplified manner while satisfying required performance and a sensor cleaning device including the same.

The present disclosure is not limited to the foregoing, and other aspects not mentioned herein should be clearly understood by one having ordinary skill in the art to which the present disclosure pertains based on the description below.

The features of the present disclosure that achieve the aforementioned aspects and effects, and perform the characteristic functions described below, are as follows.

According to some embodiments of the present disclosure, a pump may include: a housing; a drive shaft configured to rotate within the housing, a plurality of diaphragms arranged within the housing and connected to the drive shaft, and a plurality of chambers defined by the housing and each of the plurality of diaphragms. The plurality of chambers may be configured to draw in or discharge a fluid by rotating of the drive shaft, and the fluid may be drawn into or discharged from each chamber per unit rotation of the drive shaft.

According to some embodiments of the present disclosure, a sensor cleaning device may include the pump, a passage configured to allow fluids discharged from each of the plurality of chambers of the pump to be combined and moved, and a nozzle configured to fluidly communicate with the passage and spray the combined fluid.

Other aspects and embodiments of the present disclosure are discussed infra.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed infra.

### BRIEF DESCRIPTION OF THE DRAWINGS

The above and other features of the present disclosure are now described in detail with reference to certain embodiments thereof illustrated in the accompanying drawings which are given herein below by way of illustration only, and thus are not limitative of the present disclosure, and wherein:

FIG. 1 is a perspective view of a pump according to an embodiment of the present disclosure;

FIG. 2 is a cross-sectional view of a pump according to an embodiment of the present disclosure;

FIG. 3 is one side view of a pump according to an embodiment of the present disclosure;

FIG. 4 is a cross-sectional view of a pump according to an embodiment of the present disclosure;

FIG. 5 is an exploded perspective view of some components of a pump according to an embodiment of the present disclosure;

FIG. 6 illustrates an inlet port and an outlet port of a pump according to an embodiment of the present disclosure;

FIG. 7 illustrates an intake operation of a pump according to an embodiment of the present disclosure;

FIG. 8 illustrates a discharge operation of a pump according to an embodiment of the present disclosure;

FIG. 9 is a perspective view of a pump according to an embodiment of the present disclosure;

FIG. 10 is a diagram of a sensor cleaning device including a pump according to an embodiment of the present disclosure; and

FIG. 11 schematically illustrates a side view of the vehicle.

It should be understood that the appended drawings are not necessarily to scale, presenting a somewhat simplified representation of various features illustrative of the basic principles of the present disclosure. The specific design features of the present disclosure, including, for example, specific dimensions, orientations, locations, and shapes, should be determined in part by the particular intended application and usage environment.

In the figures, the reference numbers refer to the same or equivalent parts of the present disclosure throughout the several figures of the drawing.

### DETAILED DESCRIPTION

Descriptions of specific structures or functions presented in the embodiments of the present disclosure are merely exemplary for the purpose of explaining the embodiments according to the concept of the present disclosure, and the embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

In the present disclosure, terms such as “first” and/or “second” may be used to describe various components, but the components are not limited by the terms. These terms are only used to distinguish one component from another. For example, a first component could be termed a second component, and similarly, a second component could be termed a first component, without departing from the scope of exemplary embodiments of the present disclosure.

When a component is referred to as being “connected to” or “brought into contact with” another component, the component may be directly connected to or brought into contact with the other component, or intervening components may also be present. In contrast, when a component is referred to as being “directly connected to” or “brought into direct contact with” another component, there is no intervening component present. Other terms used to describe relationships between components should be interpreted in a like fashion (e.g., “between” versus “directly between,” “adjacent” versus “directly adjacent,” etc.).

Throughout the specification, like reference numerals indicate like components. The terminology used herein is for the purpose of illustrating embodiments and is not intended to limit the present disclosure. In this specification, the singular form includes the plural sense, unless specified otherwise. The terms “comprises” and/or “comprising” used in this specification mean that the cited component, step, operation, and/or element does not exclude the presence or addition of one or more of other components, steps, operations, and/or elements.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

Hereinafter, the present disclosure is described in detail with reference to the accompanying drawings.

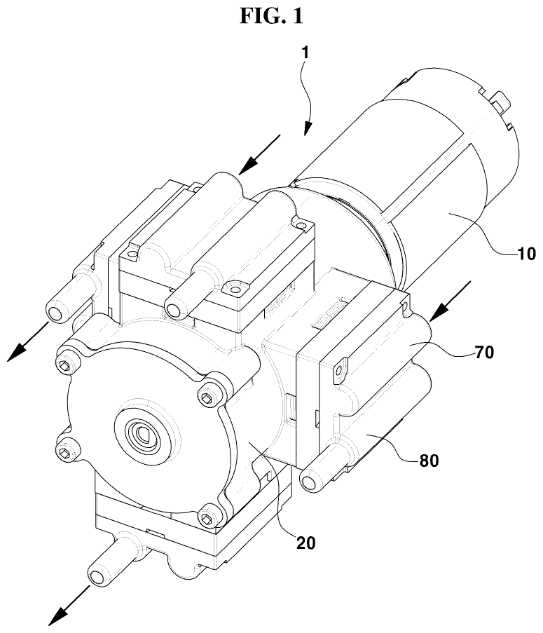

As illustrated in FIG. 1, a pump 1 is configured to move a fluid from one place to another. The fluid may be pressurized by the pump 1 and sprayed on a target. For example, the fluid may be air. The pump 1 may be driven by a motor 10.

The pump 1 includes a housing 20. The motor 10 may be operably coupled to the housing 20. In an embodiment, the motor 10 may be an electric motor. As a non-limiting example, the motor 10 may be a direct-current motor. The motor 10 includes a motor shaft 12. The motor shaft 12 is configured to rotate when power is supplied to the motor 10.

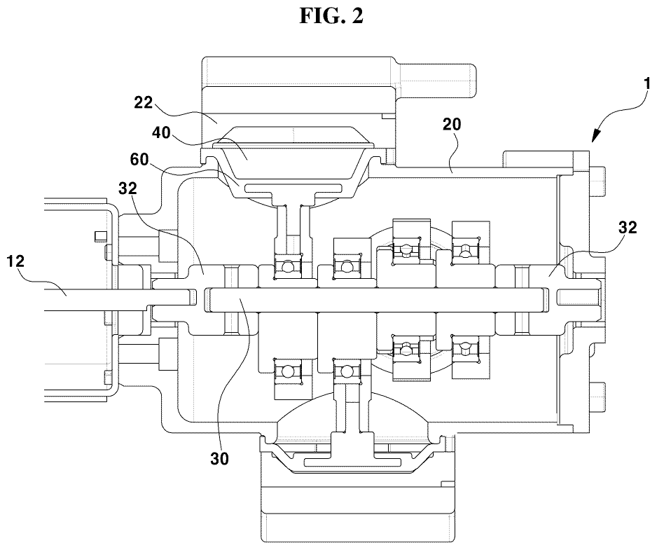

As illustrated in FIG. 2, the motor 10 is configured to drive the pump 1. The rotational power of the motor 10 may be delivered to the pump 1 through the motor shaft 12. In one embodiment, the motor shaft 12 may be integrated with a drive shaft 30 of the pump 1. In other words, the motor shaft 12 may directly deliver the rotational power to the pump 1. In another embodiment, the motor shaft 12 may be connected to the drive shaft 30 arranged within the housing 20. The drive shaft 30 may be rotatably supported by the housing 20. For example, the drive shaft 30 may be rotatably supported by the housing 20 through a support portion 32. In one embodiment, the drive shaft 30 may be connected to the motor shaft 12 through the support portion 32 to receive the rotational force from the motor shaft 12. As described below, the pump 1 may include a plurality of chambers 40a, 40b, 40c, 40d (collectively referred to as “chambers 40”), which may result in an increase in the axial length of the pump 1 and/or the length of the drive shaft 30. When the motor shaft 12 and the drive shaft 30 are formed separately, and the support portion 32 is provided, instability in behavior due to the increase in length may be avoided or prevented.

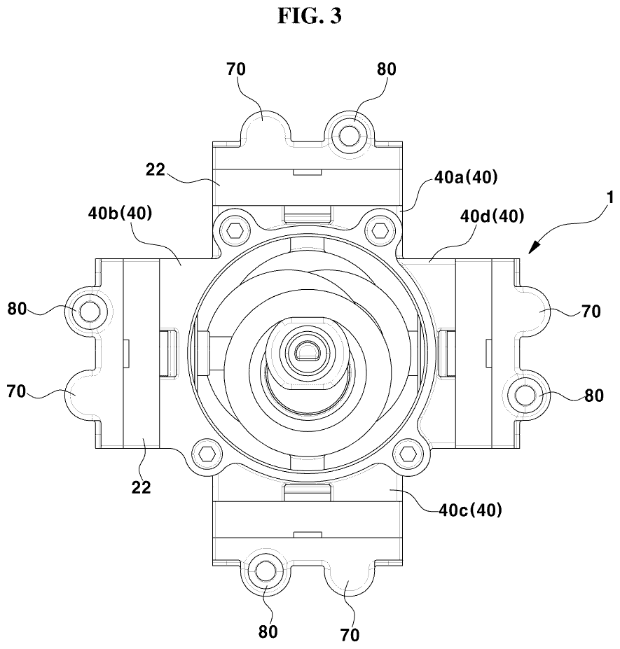

The pump 1 may include one or more chambers 40 or cylinders. Each chamber 40a, 40b, 40c, 40d is configured to draw, compress, and discharge a fluid. Referring to FIG. 3, according to an embodiment of the present disclosure, the pump 1 may include at least four chambers 40a, 40b, 40c, and 40d. The four chambers 40a, 40b, 40c, and 40d may be connected in parallel within the pump 1 and may operate independently from one another. The pump 1 of the present disclosure may address the limitations in securing flow rate, which has been a problem in pumps of the related art. In one embodiment, when any two of the four chambers 40a, 40b, 40c, and 40d are in discharge operation, the other two of the four chambers 40a, 40b, 40c, and 40d are configured to perform an intake operation. Conversely, when any two of the four chambers 40a, 40b, 40c, and 40d are in intake operation, the other two of the four chambers 40a, 40b, 40c, and 40d are configured to perform a discharge operation. For example, when a discharge motion occurs in the two chambers on the left in FIG. 2, an intake motion occurs in the two chambers on the right in FIG. 2. When the intake motion occurs in the two chambers on the left, the two chambers on the right may perform the discharge operation. This is merely an example, and other combinations of operations may also be possible. Each of the chambers 40a, 40b, 40c, 40d may generate a flow by drawing in and discharging fluid through a diaphragm 60 connected to a connection plate 50, which is configured to be driven by the motor 10.

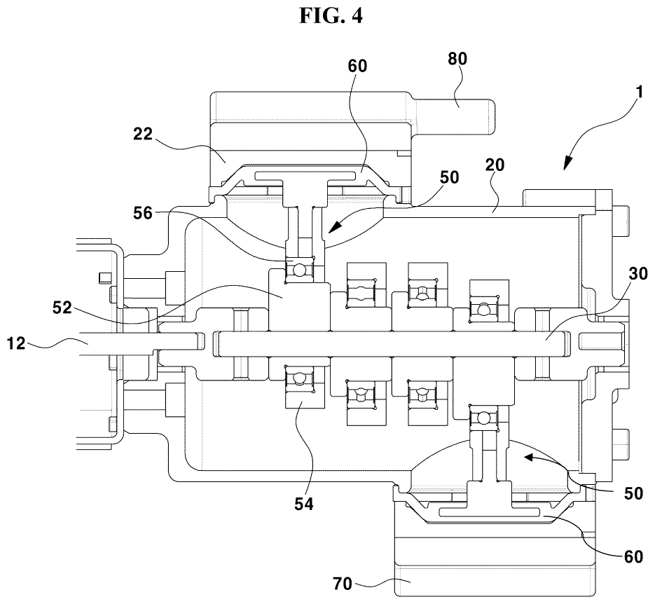

As illustrated in FIG. 4, the connection plate 50 is configured to be mounted on the drive shaft 30, and the diaphragm 60 is mounted on the connection plate. The piston movement of the connection plate 50 causes the diaphragm 60 to compress or expand the chamber 40, which leads the fluid to be drawn in, compressed, and discharged. The connection plate 50 and the diaphragm 60 may be provided in a number corresponding to the number of the chambers 40 provided in the pump 1. Each of connection plates 50 may be coupled to the drive shaft 30 along the axial direction of the drive shaft 30.

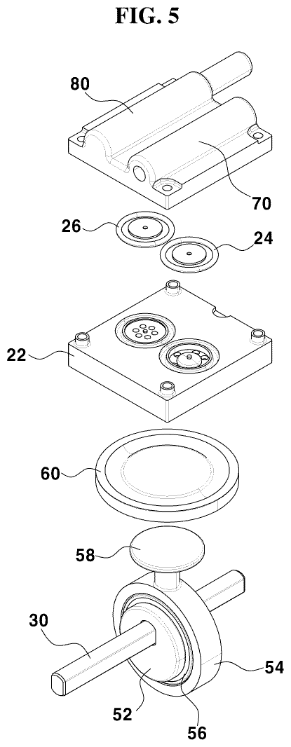

As illustrated in FIG. 5, in one embodiment, the drive shaft 30 may be eccentrically arranged on the connection plate 50. Thus, the rotation of the drive shaft 30 may cause the connection plate 50 to linearly reciprocate. In one embodiment, the connection plate 50 may include a bush portion 52 and a ring portion 54. The bush portion 52 is eccentrically coupled to the drive shaft 30 and rotates together with the drive shaft 30. In one embodiment, the bush portion 52 and the drive shaft 30 may be assembled in a loose fit. The ring portion 54 may be arranged on the rim of the bush portion 52. A bearing 56 is disposed between the bush portion 52 and the ring portion 54 such that the bush portion 52 may rotate together with the drive shaft 30, while the ring portion 54 linearly reciprocates by the rotation of the bush portion 52.

The diaphragm 60 may be mounted to the ring portion 54. In one embodiment, the ring portion 54 may include an arm 58 extending radially outward from the ring portion 54. The diaphragm 60 may be mounted on the arm 58. An end portion or an outer circumferential portion of the diaphragm 60 may be secured to the housing 20.

The diaphragm 60 and the housing 20 may define the chamber 40 being expansible or contractible. In one embodiment, the housing 20 may include a separator plate 22. The separator plate 22 may be arranged within the housing 20, and the chamber 40 may be defined by the diaphragm 60 and the separator plate 22. In one example, the separator plate 22 may be integrated with the housing 20. In another example, the separator plate 22 may be separate from the housing 20 but be detachably coupled to the housing 20.

The separator plate 22 may be provided with a pair of valves 24 and 26. The valves 24 and 26 each may be selectively opened or closed with respect to the intake or discharge operation of the chamber 40. The valves 24 and 26 may also serve to prevent the backflow of the pressurized fluid in a passage 90. In one embodiment, the valves 24 and 26 may be an intake valve 24 and a discharge valve 26. The intake valve 24 may be fluidly connected to an inlet port 70 configured to allow a fluid to flow in from the outside of the chamber 40. The discharge valve 26 may be fluidly connected to an outlet port 80 configured to allow a fluid to flow out from the inside of the chamber 40.

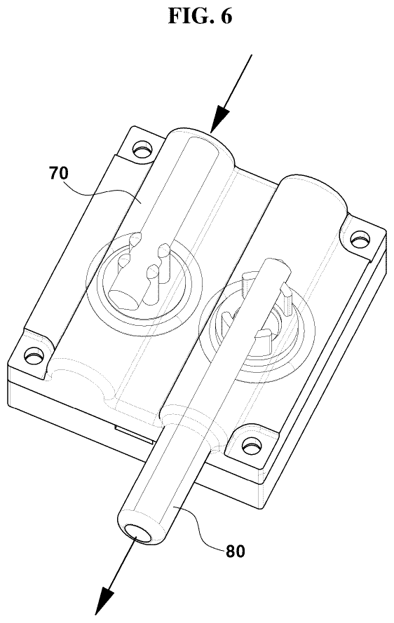

Referring to FIG. 6, the inlet port 70 and the outlet port 80 may be provided for each chamber 40. According to the present disclosure, in order to prevent backflow due to the flow being discharged from each chamber 40, the inlet port 70 and the outlet port 80 are separated from each other, and the inlet port 70 and the outlet port 80 each may be provided with a corresponding one of the valves 24 and 26.

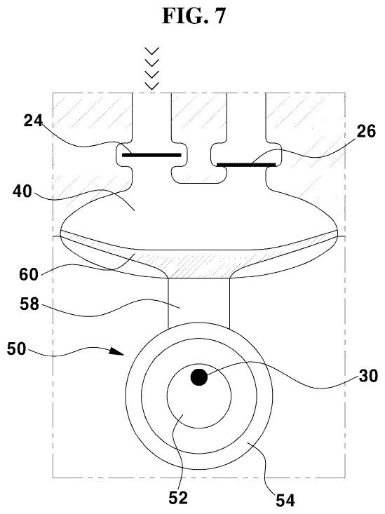

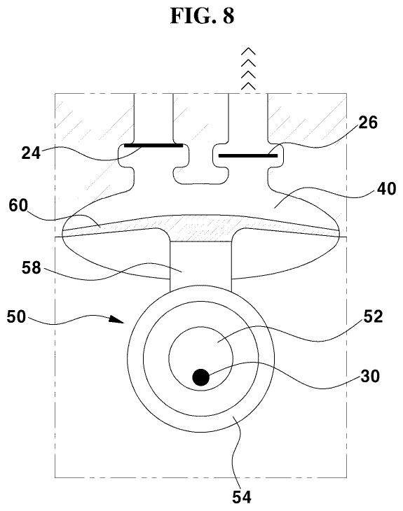

As illustrated in FIG. 7, the intake valve 24 is configured to move to an open position during the intake operation of the chamber 40 or during the expansion of the diaphragm 60 to draw in a fluid into the chamber 40 through the inlet port 70. The intake valve 24 is configured to move to a closed position during the discharge operation of the chamber 40. As illustrated in FIG. 8, the discharge valve 26 is configured to move to an open position during the discharge operation of the chamber 40 or during the contraction of the diaphragm 60 to discharge a fluid out of the pump 1 through the outlet port 80. The discharge valve 26 is configured to move to a closed position during the intake operation of the chamber 40.

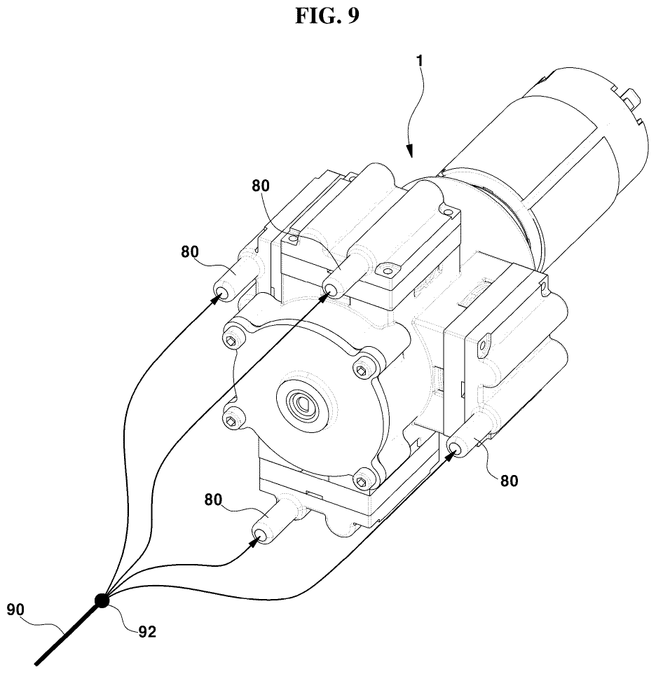

As illustrated in FIG. 9, the outlet ports 80 of the chambers 40a, 40b, 40c, and 40d are configured to merge into one passage 90. For each rotation of the drive shaft 30, the intake, compression, and discharge operations of the fluid are performed in all chambers 40a, 40b, 40c, and 40d. The fluid in each chamber 40a, 40b, 40c, 40d generated through this operation is configured to flow to a destination through the passage 90.

The pump 1 according to the present disclosure may be applied to various fields. Particularly, the pump 1 may be applied to a field where the size of the pump needs to be decreased due to a space limit and where increased flow rate is needed.

For example, the pump 1 may be configured to supply a fluid or air for cleaning a sensor mounted on a vehicle V. Vehicles may be equipped with driver assistance systems for safe driving of drivers. Moreover, autonomous vehicles capable of travelling on their own without driver intervention have recently appeared. Vehicles equipped with driver assistance systems or autonomous vehicles are equipped with various sensors to recognize the surroundings of the vehicle. For example, the sensors may include at least one of a camera, LiDar sensor, radar sensor, or the like.

In order for a sensor to maintain its designated function, the surface of the sensor must be kept clean to a certain degree or higher. For example, when foreign substances, such as water droplets, stains, or dust, are attached to the surface of a camera mounted on a vehicle, it becomes difficult to secure a field of view. The pump 1 may be configured to clean such a sensor, such as a camera. The pump 1 according to the present disclosure may secure a flow rate of 35 LPM (liters per minute) and a pressure of at least about 1.4 bar under no-load condition, in order to remove foreign substances from the sensor.

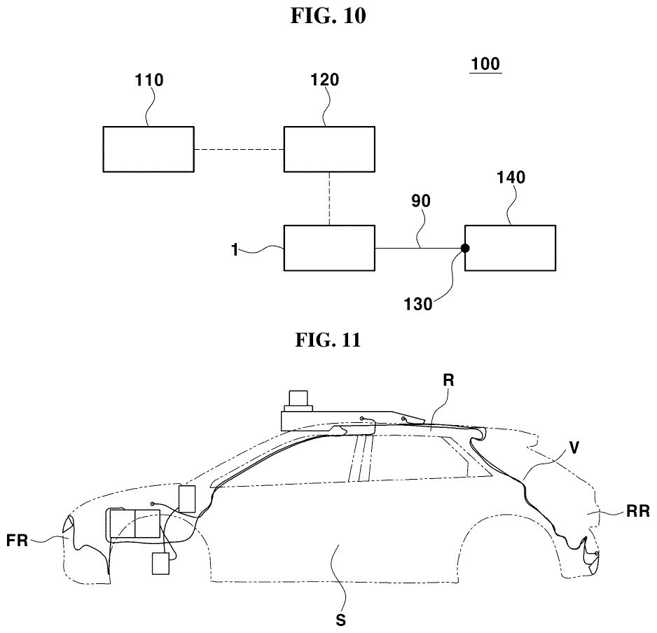

As illustrated in FIG. 10, according to some embodiments of the present disclosure, the sensor cleaning device 100 may include the pump 1. As illustrated in FIG. 11, the sensor cleaning device 100 is configured to clean one or more environment sensors 140 mounted at the front FR, rear RR, sides S, or roof R of the vehicle V. As a non-limiting example, the environment sensors 140 may include a camera, LiDar sensor, radar sensor, or the like.

For example, when the camera 140 mounted at the rear RR of the vehicle V is stained during reverse parking, the driver of the vehicle V may request the pump 1 to clean the camera 140. In one embodiment, the driver's request may be transmitted to the pump 1 using an activation button provided in the vehicle V or a request button 110, such as a device configured to communicate with the vehicle V by wire or wirelessly.

Upon receiving the driver's request, the pump 1 may operate. For example, the sensor cleaning device 100 may include a controller 120 configured to control the operation of the pump 1 or a power source configured to supply power to the pump 1. In one example, the controller 120 is configured to operate the pump 1 in response to a cleaning request from the driver. Air pressurized by the pump 1 may be directed to a nozzle 130 which is in fluid communication with the passage 90. By operating the pump 1, air may be sprayed onto the camera 140 through the nozzle 130 provided on or around the camera 2. Here, the camera 140 is merely one example, and cleaning of other types of sensors may also be possible. Moreover, the air supplied by the pump 1 may be directed to sensors located not only at the rear RR of the vehicle V but also at the front FR, roof R, or sides S.

The sensor cleaning device including the pump according to an embodiment of the present disclosure may improve the marketability of a vehicle by enabling cleaning of sensors.

Moreover, the pump according to the present disclosure, being compact in size, may overcome the space limitations associated with the characteristics of the vehicle. The pump may also satisfy the performance required for cleaning of sensors by including a plurality of chambers or at least four chambers. Because the pump according to the present disclosure may secure an increased flow rate compared to the related art and may maintain a high flow rate and stable operation at maximum pressure, the pump may be applied not only to a vehicle but also to any field that needs a small pump.

For a small pump, a bush and a connection rod may be eccentrically assembled to a motor shaft by being press-fitted onto a common axis. When the pump includes two chambers and operates with only an up-down stroke, a balance weight may be required in a direction opposite to the eccentric direction to maintain operational stability. However, the present disclosure provides an improved structure that enhances the operational stability of the piston by increasing the number of chambers and the strokes, and thus may maintain the amount of unbalance close to zero without the use of a balance weight. To overcome the difficulty in implementation caused by the load imposed on chamber or cylinder operation when employing the structure of a conventional pump, the present disclosure provides a structure in which the bearing and the connection plate are press-fit assembled, the bearing and the bush portion are assembled in a loose fit, and the bush portion and the drive shaft are assembled in a loose fit, enhancing the operational stability and reducing driving torque.

As is apparent from the above description, the present disclosure provides the following effects.

According to the present disclosure, provided is a pump configured to offer improved performance at a given size.

According to the present disclosure, a pump is configured to supply a fluid for cleaning a sensor of a vehicle in a simplified manner while satisfying required performance. The present disclosure also provide a sensor cleaning device including the pump.

Effects of the present disclosure are not limited to what has been described above, and other effects not mentioned herein will be clearly recognized by those having ordinary skill in the art based on the above description.

It should be apparent to those of ordinary skill in the art to which the present disclosure pertains that the present disclosure described above is not limited by the above-described embodiments and the accompanying drawings, and various substitutions, modifications and changes are possible within a range that does not depart from the technical idea of the present disclosure.

What is claimed is:

1. A pump comprising:
a housing;
a drive shaft configured to rotate within the housing;
a plurality of diaphragms arranged within the housing and connected to the drive shaft; and
a plurality of chambers defined by the housing and each of the plurality of diaphragms, wherein the plurality of chambers is configured to draw in and discharge a fluid by rotation of the drive shaft,
wherein the fluid is drawn into or discharged from each chamber per unit rotation of the drive shaft.

2. The pump of claim 1, further comprising a motor configured to supply a rotational force to the drive shaft,
wherein the drive shaft is integrated with or formed separately from, a motor shaft of the motor.

3. The pump of claim 1, further comprising a plurality of connection plates, wherein the drive shaft is eccentrically mounted to the plurality of connection plates, and the plurality of diaphragms is respectively mounted to the plurality of connection plates.

4. The pump of claim 3, wherein each connection plate of the plurality of connection plates comprises:
a bush portion eccentrically coupled to the drive shaft; and
a ring portion comprising an arm to which a corresponding diaphragm among the plurality of diaphragms is mounted, the ring portion configured to be arranged on an external side of the bush portion,
wherein the bush portion is configured to rotate relative to the ring portion.

5. The pump of claim 4, wherein each connection plate of the plurality of connection plates further comprises:
a bearing disposed between the bush portion and the ring portion and configured to rotatably support the bush portion relative to the ring portion.

6. The pump of claim 1, wherein the housing comprises a plurality of separator plates configured to respectively define the plurality of chambers with the plurality of diaphragms.

7. The pump of claim 6, wherein each separator plate of the plurality of separator plates comprises a pair of valves configured to be selectively opened, wherein the pair of valves comprises an intake valve and a discharge valve.

8. The pump of claim 7, wherein the intake valve is configured:
to be opened when the fluid is drawn into a corresponding chamber among the plurality of chambers and
to be closed when the fluid is discharged from the corresponding chamber.

9. The pump of claim 7, wherein the discharge valve is configured:
to be closed when the fluid is drawn into a corresponding chamber among the plurality of chambers and
to be opened when the fluid is discharged from the corresponding chamber.

10. The pump of claim 1, wherein each chamber of the plurality of chambers comprises:
an inlet port configured to allow the fluid to flow into a corresponding chamber among the plurality of chambers; and
an outlet port configured to discharge the fluid from the corresponding chamber.

11. The pump of claim 10, comprising:
an intake valve disposed between the corresponding chamber and the inlet port; and
a discharge valve disposed between the corresponding chamber and the outlet port.

12. The pump of claim 1, wherein the plurality of chambers comprises at least four chambers formed independently of one another.

13. The pump of claim 12, wherein among the at least four chambers, some chambers and the remaining chambers alternately drawn in or discharge the fluid.

14. The pump of claim 12, wherein, when the fluid is drawn into some of the at least four chambers, the fluid is discharged from the remaining chambers of the at least four chambers.

15. A sensor cleaning device comprising:
a pump, wherein the pump comprises:
a housing:
a drive shaft configured to rotate within the housing;
a plurality of diaphragms arranged within the housing and connected to the drive shaft; and
a plurality of chambers defined by the housing and each of the plurality of diaphragms, wherein the plurality of chambers is configured to draw in and discharge a fluid by rotation the drive shaft, and the fluid is drawn into or discharged from each chamber per unit rotation of the drive shaft;
a passage configured to allow the fluid discharged from each chamber of the plurality of chambers to be combined and moved; and
a nozzle configured to fluidly communicate with the passage and spray the combined fluid.

16. The sensor cleaning device of claim 15, wherein the nozzle is configured to spray the fluid onto a sensor that is configured to detect a surrounding environment of a vehicle.

17. The sensor cleaning device of claim 16, wherein the sensor comprises at least one of a camera, a LiDar sensor, or a radar sensor mounted on the vehicle.

18. The sensor cleaning device of claim 15, wherein the fluid is air.

19. The sensor cleaning device of claim 15, further comprising a request button configured to send an activation request to the pump, wherein the pump is configured to operate in response to the activation request.

20. A vehicle comprising the sensor cleaning device according to claim 15.
